(19) United States
(12) Patent Application Publication
(10) Pub. No.: US 2011/0038416 A1
(43) Pub. Date: Feb. 17, 2011

(54) VIDEO CODER PROVIDING IMPROVED VISUAL QUALITY DURING USE OF HETEROGENEOUS CODING MODES

(75) Inventors: Xiaosong ZHOU, San Jose, CA (US); Ionut HRISTODORESCU, San Jose, CA (US); Hsi-Jung WU, San Jose, CA (US); Xiaojin SHI, Fremont, CA (US)

Correspondence Address: KENYON & KENYON LLP, 1500 K STREET NW, SUITE 700, WASHINGTON, DC, 20005-1257, US

(73) Assignee: APPLE INC., Cupertino, CA (US)

(21) Appl. No.: 12/541,773

(22) Filed: Aug. 14, 2009

(51) Int. Cl. H04N 11/04

(52) U.S. Cl. 375/240.13; 375/E07.026; 375/E07.243

(57) ABSTRACT

A video coding system reduces perceptible artifacts introduced to coded video due to selection of disparate coding modes among adjacent partitions of video. When coding modes are assigned to partitions of video that likely would introduce visually perceptible coding artifacts during decode, the partitions may be subject to a coding process in which a selected partition is coded according to coding modes that correspond to neighboring partitions, then decoded. The decoded data of the selected partition may be recoded according to a different coding mode. Coding artifacts that otherwise might be introduced by the different coding mode may be avoided by first coding the corresponding partition in a manner that is consistent with neighboring partitions, then decoding the coded partition and re-coding the decoded data according to the different mode. In an embodiment, a quantization parameter may be reduced between a first code and the recode. The coding technique may be applied to partitions of various scales—e.g., to pixel blocks or frames.

### BACKGROUND

The present invention relates to video coding.

Modern video coding standards, such as the H.264 standard, provide a large set of compression modes and tools for an encoder to choose from. A video coder typically operates according to a coding policy, which causes the video encoder to select certain modes to compress individual data partitions in order to achieve appropriate data compression or enable certain video features. These partitions can be one or a group of pictures, slices, macroblocks or blocks. Partitions that belong to a common segment of video, either temporally or spatially, can be coded with different modes owing to requirements of the coding policies that cause the partitions to be assigned different modes even though the video content of the partitions may be similar. Sometimes, the reconstruction of these differently coded partitions can generate recovered video data that has a visual difference and can be observed during playback. Such differences may cause certain partitions to “stand out” in a homogeneous segment, causing visual artifacts such as blinking, flashing, flickering and blocking artifacts.

It can be useful to consider a coding policy as representing a plurality of different coding goals. A base policy may cause the video coder to select coding modes to achieve a high level of compression and yet still maintain a predetermined level of image quality when coded video data is decoded and displayed at a video decoder. Coding mode decisions made according to the base policy may be considered to be “default” coding decisions. The coding policy further may include additional coding policies which cause the video coder to make coding decisions that differ from the default coding decisions due to considerations that differ from the compression/quality balance represented by the base policy. For example, a coding policy may mandate that a predetermined number of frames be coded as intra frames (commonly, “I frames”) to support random access features such as fast forward and fast review. Intra-coded frames conventionally invoke lower levels of compression than might be achieved by inter-coding modes and, therefore, the I frames generally are considered more expensive to code. Similarly, a coding policy may mandate that each pixel block location within a frame be coded as an intra-coded block at least once within a predetermined number of frames to provide resiliency against communication errors that may arise between a video encoder and a video decoder. Again, intra-coded pixel blocks are considered more expensive than inter-coded counterparts. The features of coding policies that cause a video coder to make coding mode decisions that differ from the default coding decisions are called “external constraints” herein. When coding decisions are made according to external constraints, they are likely to lead to the visually-perceptible artifacts noted above.

No known video coding system codes video data to satisfy external constraints of a video coding policy and provides adequate protection against the visually perceptible artifacts noted above. Accordingly, there is a need in the art for an improved video coding system.

### BRIEF DESCRIPTION OF THE DRAWINGS

FIG. 1 illustrates a video coding system 100 according to an embodiment of the present invention.

FIG. 2 illustrates a method according to an embodiment of the present invention.

FIG. 3 illustrates exemplary operation of an embodiment of the present invention.

FIG. 4 illustrates operation of an embodiment of the present invention in another example.

FIG. 5 illustrates another method according to an embodiment of the present invention.

FIG. 6 illustrates exemplary operation of another embodiment of the present invention.

FIG. 7 illustrates operation of an embodiment of the present invention in another example.

### DETAILED DESCRIPTION

Embodiments of the present invention provide a video coding system and method that reduce perceptible artifacts introduced to coded video due to selection of disparate coding modes among adjacent partitions of video. According to the method, when coding modes are assigned to partitions of video that likely would introduce visually perceptible coding artifacts during decode, the partitions may be subject to a coding process in which a selected partition is coded according to coding modes that correspond to neighboring partitions, then decoded. The decoded data of the selected partition may be recoded according to a different coding mode. Coding artifacts that otherwise might be introduced by the different coding mode may be avoided by first coding the corresponding partition in a manner that is consistent with neighboring partitions, then decoding the coded partition and re-coding the decoded data according to the different mode. In an embodiment, a quantization parameter may be reduced between a first code and the recode. The principles of the present invention may be applied to partitions of various scales—e.g., to pixel blocks or frames.

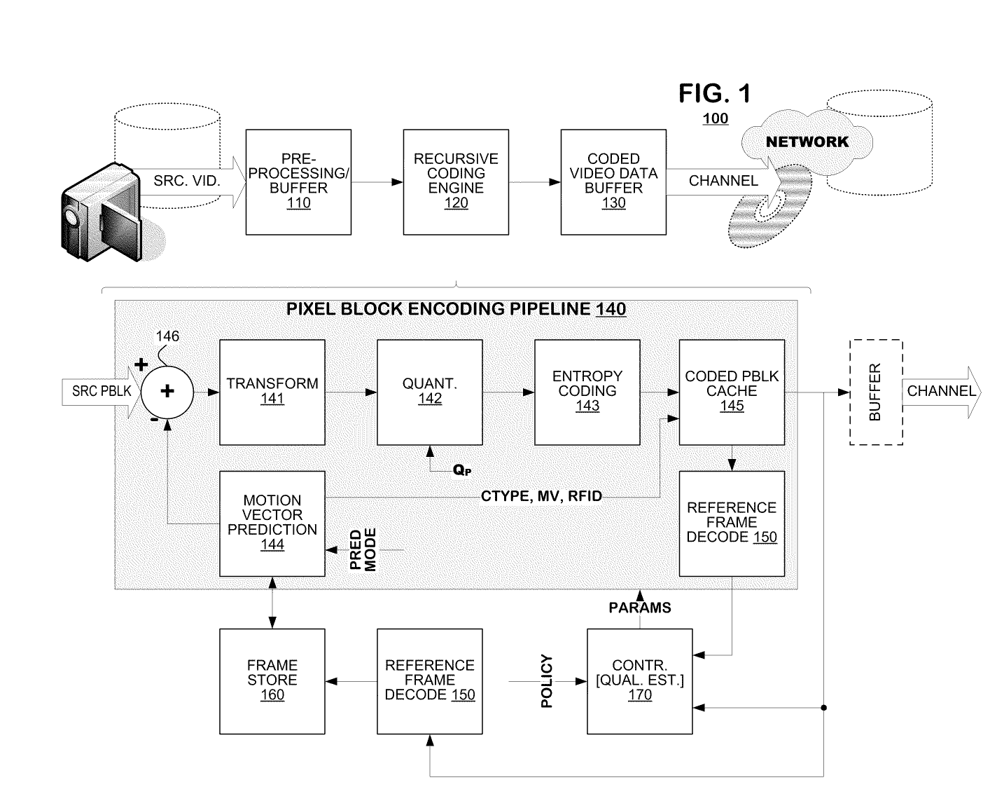

FIG. 1 is a simplified block diagram of a video coding system 100 according to an embodiment of the present invention. The system 100 may include a video pre-processor and buffer 110 (“pre-processor”), a recursive coding engine 120 and a coded video data buffer. Source video may be input into the pre-processor 110 from a camera device or from storage. The pre-processor 110 may buffer the input data and may perform pre-processing functions such as video segmentation, which may parse frames of the video data into pixel blocks. The pre-processor 110 also may perform various pre-processing functions, such as video filtering, motion estimation and color correction, to condition the source video for coding. The coding engine 120 may code the processed data according to a variety of coding modes and coding parameters to achieve data compression. The compressed video may be stored by the coded video data buffer 130 where they may be combined into a common bit stream to be delivered to a channel. The channel may deliver the coded video data to a decoder device (not shown) that may recover a replica of the source video data from the coded video data for display or for storage. In this regard, a channel may be embodied as a storage device, such as an electrical, optical or magnetic storage medium, or as a communication channel supported by a computer or communication network.

FIG. 1 also illustrates a portion of the coding engine 120 according to an embodiment. The coding engine 120 may code video data on a frame-by-frame basis and a pixel block-by-pixel block basis within each frame. The coding engine 120 may include a pixel block encoder 140 that may code source pixel blocks input to the coding engine into coded pixel blocks. The pixel block encoder 140 may include a transform unit 141, a quantizer unit 142, an entropy coder 143, a motion vector prediction unit 144, a coded pixel block cache 145, and a subtractor 146. The transform unit 141 may convert input pixel block data into an array of transform coefficients, for example, by a discrete cosine transform (DCT) process or a wavelet process. The quantizer unit 142 may truncate transform coefficients based on a quantization parameter. The quantization parameter may be output to the channel when the pixel block is coded. The entropy coder 143 may code the resulting truncated transform coefficients by run-value, run-length or similar entropy coding techniques. Thereafter, the coded pixel blocks may be stored in a cache 145. Eventually, coded pixel blocks may be output to the coded video data buffer 130 where they are merged with other elements of the coded video data and output to the channel.

The coding engine 120 also may include a reference frame decoder 150 and a frame store 160. During operation, the coding engine 120 may designate certain frames as “reference frames,” meaning they can be used as prediction references for other frames. The operations of the pixel block encoder 140 can introduce data losses and, therefore, the reference frame decoder 150 may decode coded video data of each reference frame to obtain a copy of the reference frame as it would be generated by a decoder (not shown). The decoded reference frame may be stored in the frame store 160. When coding other frames, a motion vector prediction unit 144 may retrieve pixel blocks from the frame store 160 according to motion vectors (“mvs”) and supply them to a subtractor for comparison to the pixel blocks of the source video. In some coding modes, for example intra coding modes, motion vector prediction is not used. In inter coding modes, by contrast, motion vector prediction is used and the pixel block encoder outputs motion vectors identifying the source pixel block that was used at the subtractor 146.

During operation, a video encoder 120 may operate according to a coding policy that selects frame coding parameters to achieve predetermined coding requirements. For example, a coding policy may select coding parameter to meet a target bitrate for the coded video data and to balance parameter selections against estimates of coding quality. Further the coding policy may specify external constraints to be met even though they might contribute to increased bitrate. A controller 170 may configure operation of the coding engine 120 according to the coding policy via coding parameter selection (params) such as coding type, quantization parameters, motion vectors, and reference frame identifiers. Each combination of parameter selections can be considered a separate coding “mode” for the purposes of the present discussion. The controller 170 may monitor performance of the coding engine 120 to code various portions of the input video data and may cause video data to be coded, decoded and re-coded according to the various embodiments of the invention as discussed herein. Thus, the coding engine 120 is shown as a recursive coding engine.

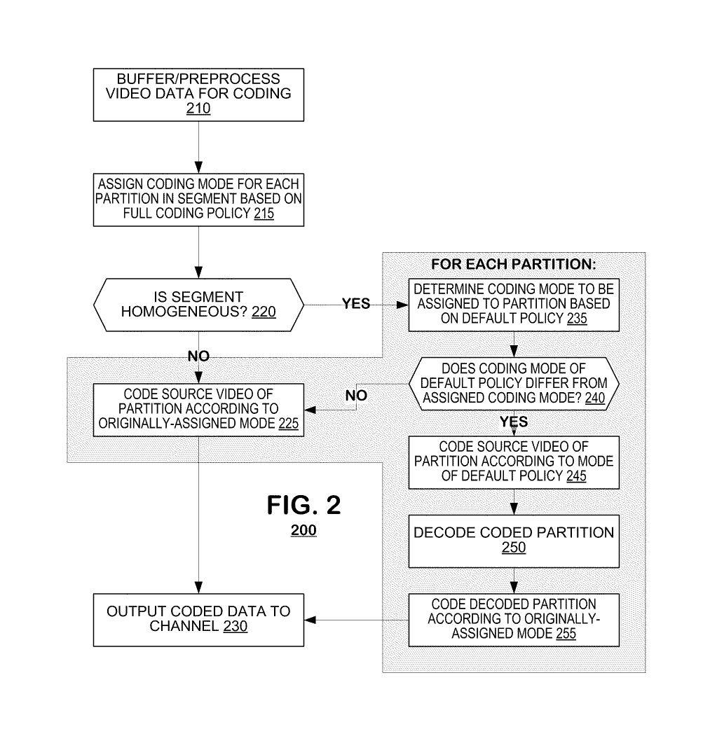

FIG. 2 illustrates a method 200 according to another embodiment of the present invention. According to the method, source video data may be buffered and/or pre-processed prior to coding (box 210). Thereafter, each segment within the video data may be examined and partitions therein may be assigned a coding mode based on the full coding policy (box 215). In this embodiment, the coding mode assignments may include mode decisions based on external constraints. The method 200 then may determine whether the segment being coded is homogeneous (box 220). If the segment is not homogenous, the method may code the source video of each partition according to the coding mode assigned at step 215 and output the coded data to the channel (boxes 225-230).

If the segment is homogeneous, then for each partition, the method 200 may determine what coding mode would have been applied to the respective partition according to the base coding policy, without consideration of the external constraint(s) (box 235). The method 200 may determine if the coding modes assigned to the respective partitions at boxes 215 and 235 differ from each other (box 240). If so, the method 200 may code the respective partition according to the mode selected by the base policy, may decode the coded data and then may re-code the decoded data of the respective partition according to the originally-assigned mode (boxes 245-255). If not, the respective partition can be coded according to the originally-assigned mode, the mode assigned at box 215 (box 225). At the conclusion of operation of boxes 225 or 255, the coded data may be output to the channel (box 230).

During operation, by coding the partitions according to a base policy (box 245) without regard to external constraints, then re-coding the partitions that are subject to the external constrains from decoded video data (box 255), it is expected that recovered video data will exhibit fewer coding artifacts than might be observed without operation of the method of FIG. 2. The first coding is likely to induce coding losses that are uniform throughout the segment. When the coded video data of the identified partitions is decoded and then re-coded according to the external constraints, the re-coded data may include data losses encountered during the first coding and, therefore, there are likely to be fewer discontinuities between the identified partition(s) and their neighbors within the segment.

According an embodiment, when a partition is coded twice, for example at boxes 245 and 255, the method may use a lower quantization parameter for the second coding (box 255) than for the first (box 245).

A video coder may determine whether a segment of source video data is homogeneous according to various techniques. In a first embodiment, a video coder may perform motion estimation of partitions within the segment. If the partitions exhibit consistent motion, a video coder may determine that the segment is homogenous. When partitions correspond to pixel blocks, for example, video coders conventionally derive motion vectors for such partitions when coding them according to predictive coding (P mode) or bi-directionally predictive coding (B mode). If the motion vector derivation generates consistent motion vectors throughout the pixel blocks of a common segment (for example, if the motion vectors of the partitions are within a predetermined numerical range of each other), the segment may be judged to be homogeneous. Similarly, when partitions correspond to frames, video pre-processors often estimate motion of entire frames according to global motion compensation techniques. Such frame-based motion estimation may be used by embodiments of the present invention to determine whether a partition is homogeneous. In another alternative, motion estimation may be provided by an image capture device, such as a camera, to indicate motion of the image capture device as the source video was captured. Image capture devices may include motion sensors, such as accelerometers, compasses and/or gyroscopes, which permit the devices to estimate motion of the device. If camera motion falls within a predetermined threshold for a segment, the method may determine that the segment is homogeneous.

In another embodiment, a method may determine whether a segment of source video is homogeneous based on a luminance level or brightness level of the segment. If variation of brightness across partitions of the segment falls within a predetermine range of each other, the method may determine that the segment is homogeneous.

In a further embodiment, a method may determine whether a segment of source video is homogeneous based on mode decisions made by the video coder according to its base policy. If the mode decisions are consistent within a partition, for example, all pixel blocks are assigned B mode coding and the pixel blocks share common reference frames, the coder may determine that the segment is homogeneous.

In yet another embodiment, the method may determine whether a segment of source video is homogeneous based on an estimate of spatial complexity of the segment. For example, where partitions correspond to pixel blocks, a coder may estimate a distribution of transform coefficients for each partition. Different transform coefficients typically represent image content having different frequency distributions from each other. If the distribution of transform coefficients of the segment's partitions is consistent with each other, within a predetermined threshold, the coder may determine that the segment is homogeneous. Alternatively, the coder may determine that a segment is homogeneous based on an estimate of spatial stillness of the segment. The coder may determine whether the transform coefficients of the segment's partitions fall below a predetermined threshold frequency and, if so, the coder may determine that the segment is homogeneous.

In an embodiment, prior to coding, a segment may be tested to determine if it is homogenous or not. If the segment is identified as being homogeneous, it may be subject to the coding, decoding and recoding operations identified in FIG. 2 above. If the segment is identified as being non-homogeneous, the segment may be coded according to the full coding policy without attempting to decode and recode data. Such an embodiment may conserve processing resources when non-homogeneous video is encountered where processing artifacts are less likely to be visually-perceptible.

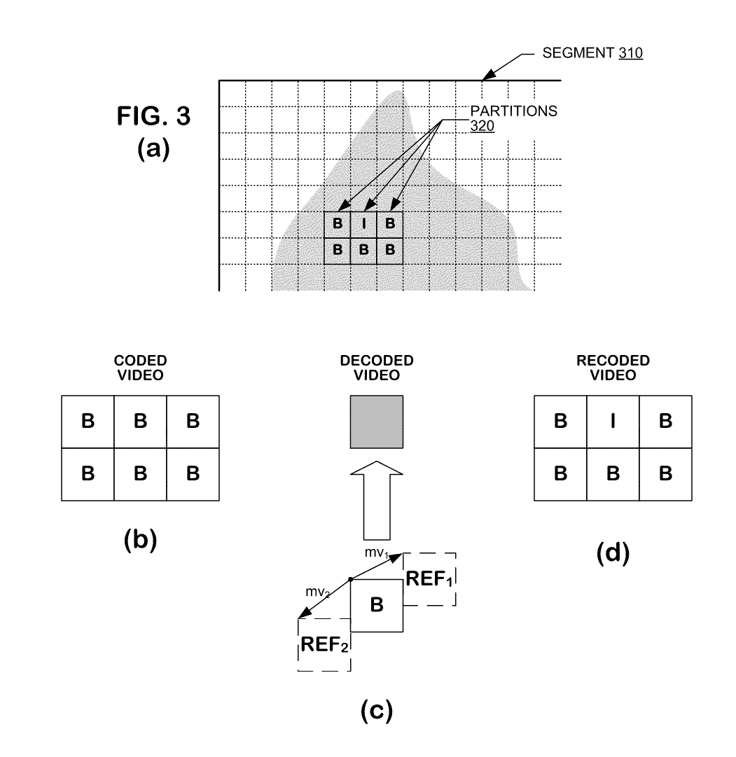

FIG. 3 illustrates an exemplary set of video data in which the techniques of the present invention can be applied. In the example of FIG. 3, a segment corresponds to a frame and partitions correspond to pixel blocks. Video coders commonly parse frames of video data into blocks or macroblocks (usually 8×8 or 16×16 arrays for video data); for the purposes of the present invention, such arrays are labeled “pixel blocks” herein. FIG. 3 (a) illustrates distribution of six (6) partitions within a segment in this example.

FIGS. 3 (b), 3 (c) and 3 (d) illustrate effects of the operation of the method of FIG. 2 in this example. During operation, a base coding policy may assign each of the six partitions illustrated in FIG. 3 (a) to be coded according to bi-directional predictive coding (a “B” mode, for short). Such coding modes conventionally are assigned when there is a high degree of temporal redundancy among pixel blocks between the frame being coded and temporally proximate frames. Thus, FIG. 3 (b) illustrates all six pixel blocks having been assigned B mode initially.

In the example of FIG. 3, an external coding constraint might require that a pixel block be coded using an intra predictive mode (an “I” mode). Typically, such constraints are imposed to provide resilience against errors. I coded blocks can be decoded without reference to blocks of any other frame and, therefore, can be recovered even if transmission errors arise; the I coding mode often codes video data at higher data rates than, for example, the B coding mode and, therefore, such coding constraints often are expensive to implement. Nevertheless, FIG. 3 (d) illustrates the six partitions of FIG. 3 (b) but in which one of the partitions has been reassigned as an I coded pixel block. During operation of the method, the coded B partition from FIG. 3 (b) may be decoded to generate decoded video data. FIG. 3 (c) illustrates decoding of the B coded partition, which might require prediction of data from a pair of reference blocks REF1, REF2 by traversing a pair of motion vectors mv1, mv2. Thereafter, the decoded partition of FIG. 3 (c) may be recoded according to the mode imposed by the external constraint.

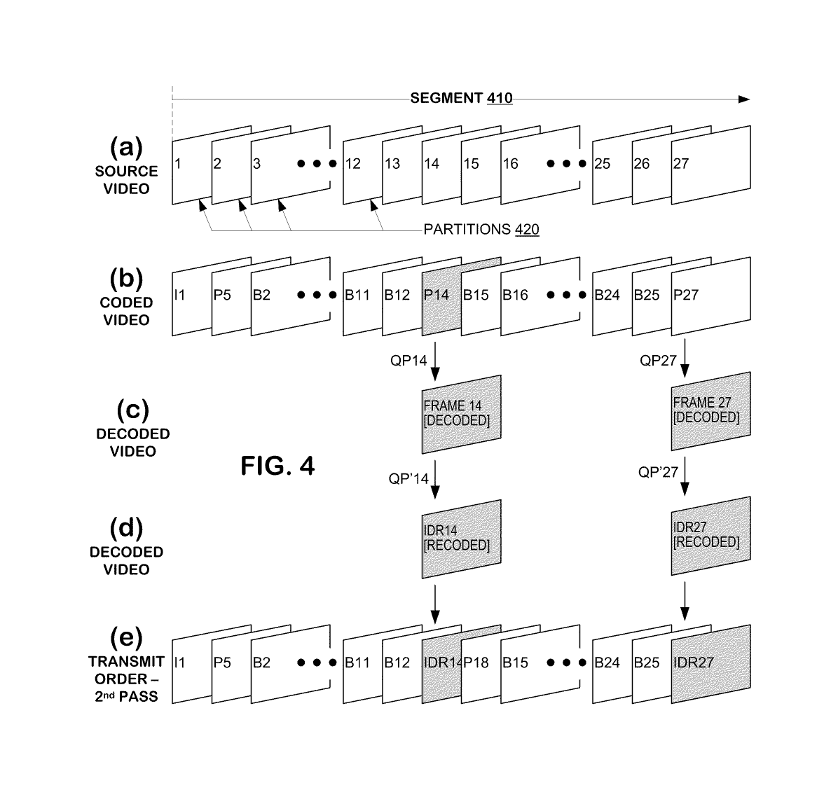

FIG. 4 illustrates another exemplary set of video data in which the techniques of the present invention can be applied. In the example of FIG. 4, a segment corresponds to a plurality of frames and a partition corresponds to individual frames. The segments may correspond to a group of frames (GOP) according to H.264 but need not be so aligned.

FIG. 4(a) illustrates a sequence of 27 frames as they may exist in display order. Before operation of the coding methods of the present invention, the source frames have not yet been assigned coding modes for processing. FIG. 4 (b) illustrates exemplary coding modes that may be assigned during operation of the method. In the examples illustrated in FIG. 4(b), frame 1 may be assigned as an I frame and frames 5, 14 and 27 may be assigned as P frames. Other frames not illustrated also may be assigned as P frames. Other frames may be assigned as B frames. FIG. 4(b) illustrates processing order that may occur due to the coding mode assignments; in many cases, the frames are coded in an order that differs from the display order.

Continuing with this example, FIG. 4 (c) illustrates decoding processing that may occur for frames 14 and 27. Frames 14 and 27 may be selected by an external constraint to be coded in a different mode than originally assigned. In the example of FIG. 4, both frames are shown as selected for coding as IDR frames. An IDR frame is a type of I frame defined by the H.264 coding protocol; according to H.264, frames that follow an IDR frame in coding order may not refer back to frames preceding the IDR frame. A decoder, therefore, can reset its operation to a known state upon reception and decode of an IDR frame. FIG. 4 (d) illustrates the frames being recoded as IDR frames and FIG. 4(e) illustrates the recoded frames being inserted into the channel bit stream.

In an embodiment, the coding, decoding and recoding of a partition may be performed on an out-of-order basis with respect to the coding of other partitions in a video sequence. Using FIG. 4 as an example, frame 14 may be decoded and recoded before other frames that occur subsequent to frame 14 in coding order (for example, frame 15) are coded for the first time. In this example, frame 15 is illustrated as a bi-directionally coded frame and likely uses frame 14 as a source of prediction. Staggering such processing operations can be useful, particularly, if the partitions that must be decoded and recoded can be identified early in video coding by virtue of the external constraints.

Alternatively, the recoding of a first partition within a video sequence can involve recoding of other partitions as well. In cases when the partitions to be recoded are identified only after the first coding is performed, it may not be possible to stagger recoding as described above. Thus, if a first partition is selected for recoding and a second partition uses the first partition as a reference for prediction, the second partition may be recoded as well.

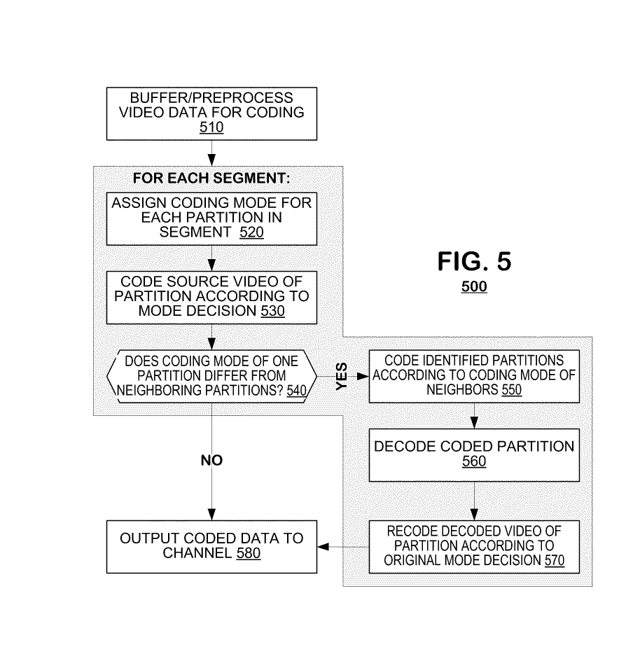

FIG. 5 illustrates another method according to an embodiment of the present invention. In this embodiment, the method 500 may code partitioned segments of video according to multiple iterations of coding to achieve coded video data with homogeneous display properties. According to the embodiment, the method may buffer the source video and, optionally, perform pre-processing operations to condition the source video for coding. The method may code partitions within a segment by assigning a coding mode to each partition in the segment (box 520). In this embodiment, the coding mode assignments may include mode decisions based on external constraints. The method further may code the segment partitions according to the assigned coding modes (box 530). Thereafter, the method may determine whether the coding mode of a partition differs from coding modes selected for neighboring partitions (box 540). If so, the method may code the source data corresponding to the differing partition according to the coding mode assigned to its neighbors (box 550) and may decoded the coded video data obtained thereby (box 560). The method further may recode the decoded video obtained at box 560 according to the coding mode assigned at box 520 (box 570). Thereafter, the coded video data of all coded partitions may be output to the channel (box 580).

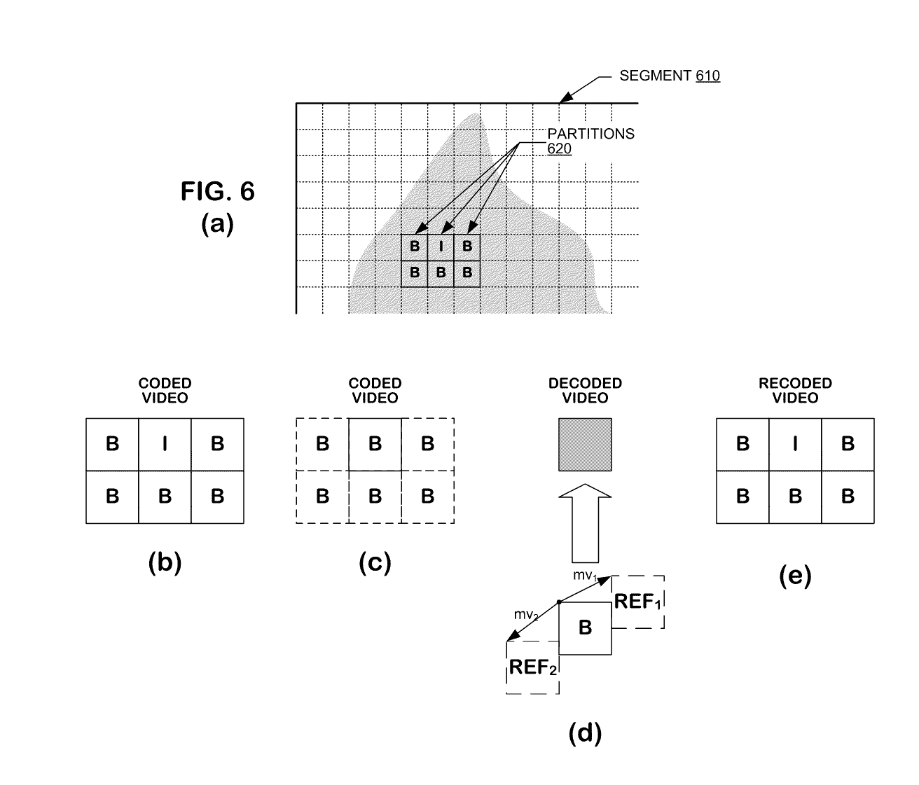

FIG. 6 illustrates an exemplary set of video data in which the techniques of the present invention can be applied. The example of FIG. 6 corresponds to the example of FIG. 3 where, again, a segment 610 corresponds to a frame and partitions 620 correspond to pixel blocks. In this example, however, the method 500 of FIG. 5 may invoke different processes than in the example of FIG. 3.

FIGS. 6 (b), 6 (c) and 6 (d) illustrate effects of the operation of the method of FIG. 5, in this example. During operation, five of the six partitions illustrated in FIG. 6 (a) may be assigned for coding according to B mode and a sixth partition may be assigned for coding according to I mode based on operation of the full coding policy. Again, the I mode selection may be based on a coding policy that requires a certain number of pixel blocks to be coded in I mode to promote error resiliency. If the coded video data generated at FIG. 6 (b) were output directly to the channel, there would be a high likelihood that visible artifacts would be observable between the I coded partition and its B coded neighbors.

During operation of the method, the I-coded partition may be identified as having a unique coding assignment as compared to neighboring partitions. According to the method, source video data corresponding to the I-coded partition may be coded according to the coding mode of the neighbor partitions—in this example, as a B-coded pixel block (FIG. 6(c)). Thereafter, the B-coded partition may be decoded (FIG. 6(d)) and the decoded obtained thereby may be re-coded according to the initially assigned coding mode—here, as an I-coded pixel block (FIG. 6(e)). The re-coded partition may be transmitted to a channel along with the coded video data of the neighboring partitions.

As noted, the method 500 of FIG. 5 is expected to generate coded video data that, when decoded, have fewer visually-perceptible artifacts between blocks. By coding a partition of source video according to a coding mode that is similar to its neighbors, then decoding the coded partition and re-coding it according to a differing coding mode, video data recovered from the recoded data is less likely to have perceptible differences when presented in proximity to the decoded data of the neighboring partitions.

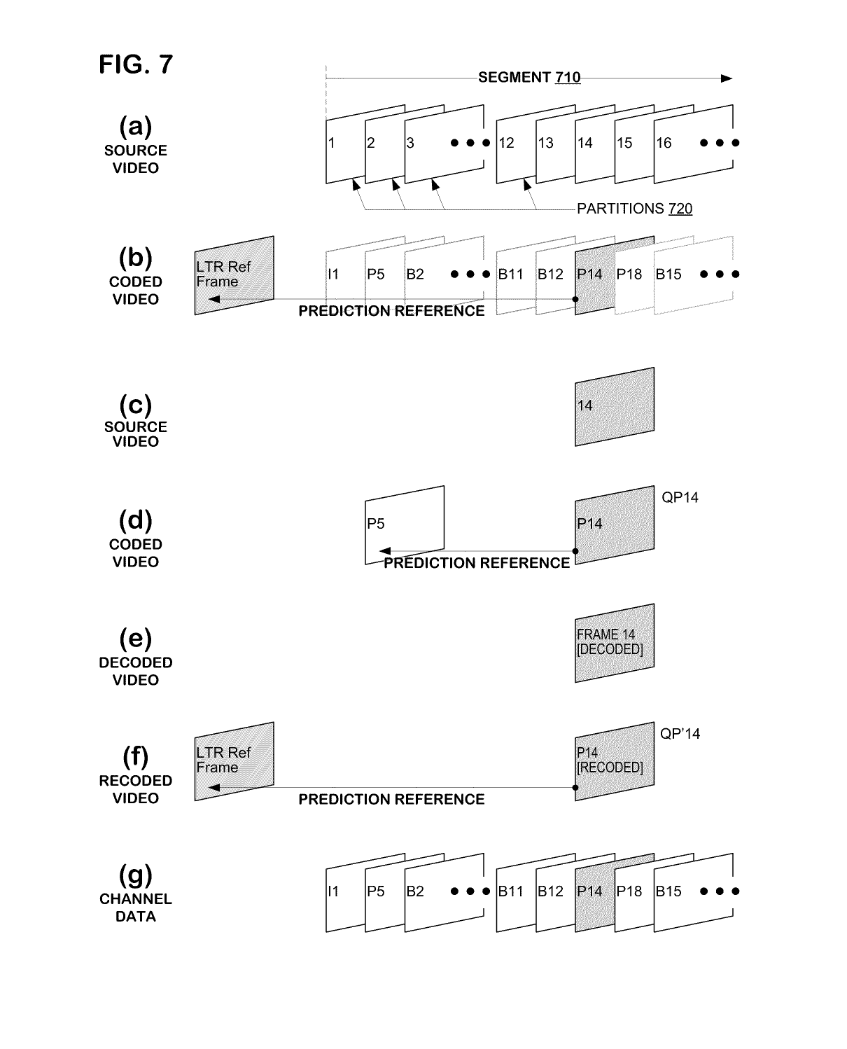

FIG. 7 illustrates application of the method of FIG. 5 to a segment 710 that corresponds to a multi-frame sequence of video. In this example, partitions 720 correspond to individual frames. FIG. 7(a) shows the frames in display order prior to coding assignments. FIG. 7(b) illustrates the example of FIG. 7(a) having been assigned coding modes according to the full coding policy. As is common in video coding, the frames' coding order may differ from the frames' display order and, therefore, FIG. 7(b) illustrates a reorganization of the video frames to account for the coding order.

As illustrated in FIG. 7(b), frame 14 may have a differing coding mode from its neighbors. In this example, frame 14 may have been assigned for coding using a long term reference frame (LTR) as a source of prediction, whereas other frames may use local reference frames (e.g., frame P5 may depend from frame I1). Due to this detected difference, a video coder may recode the source video corresponding to the coded partition (source frame 14 (FIG. 7(c)) according to the common mode. In this case, frame 14 may be coded as a P frame using a local reference frame (frame P5) as a source of prediction (FIG. 7(d)). The video coder then may decode the coded P frame (FIG. 7(e)) and recode the decoded frame according to the originally selected coding mode (FIG. 7(f)). Again, the quantization parameter used during the recoding may be much lower than the quantization parameter used during the first coding (QP14>QP′14). In this example, the decoded data obtained at FIG. 7(e) may be recoded using the LTR frame as a source of prediction. FIG. 7(g) illustrates the channel data that may be obtained in this example.

The principles of the present invention are not limited simply to coding mode assignments made to pixel blocks or to frames. Embodiments of the present invention may be extended to additional coding parameters as well. For example:
When coding pixel blocks, a coder may consider the reference frames used during predictive coding. If a first pixel block is coded with reference to a first set of reference frames (typically, a single reference frame for P-coded blocks and a pair of reference frames for B-coded blocks) but neighboring pixel blocks are coded with reference to a common second set of reference frames, the foregoing embodiments may be applied. In this example, the first pixel block may be coded with reference to the common second set of reference frames, decoded and then re-coded with reference to the first set of reference frames.
When coding pixel blocks, a coder may consider distribution of partition sizes among the partitions. Frames often can be coded according to pixel blocks of various pixel sizes for example 16×16 blocks, 8×8 blocks, 4×8 blocks, etc. If a first pixel block has a partition size that deviates from its neighbors, the pixel blocks may be reconfigured to a uniform size, coded and decoded, then the decoded data of the differently sized pixel block(s) may be resized according to its original configuration and recoded.

These examples find application to any of the foregoing coding methods illustrated in FIGS. 2 and 5.

As discussed above, the foregoing embodiments provide a coding/decoding system that performs multiple coding passes among source video data to generate recovered video data with reduced coding artifacts. The techniques described above find application in both software- and hardware-based coders. In a software-based coder, the functional units may be implemented on a computer system (commonly, a server, personal computer or mobile computing platform) executing program instructions corresponding to the functional blocks and methods described in the foregoing figures. The program instructions themselves may be stored in a storage device, such as an electrical, optical or magnetic storage medium, and executed by a processor of the computer system. In a hardware-based coder, the functional blocks illustrated in FIG. 1 may be provided in dedicated functional units of processing hardware, for example, digital signal processors, application specific integrated circuits, field programmable logic arrays and the like. The processing hardware may include state machines that perform the methods described in the foregoing discussion. The principles of the present invention also find application in hybrid systems of mixed hardware and software designs.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A video coding method, comprising:
for a segment of source video data, assigning respective coding modes for a each of a plurality of partitions of the segment according to a base coding policy,
coding each partition according to its assigned coding mode to generate first coded video data,
selecting one or more partitions to be coded according to a second coding mode,
decoding the first coded video data of the selected partitions,
recoding the decoded video data of the selected partitions according to respective second coding modes, and
generating a coded video output base on the recoded video data of the selected partitions and at least a portion of the first coded video data of the remaining partitions.

2. The video coding method of claim 1, wherein the coding and recoding of each selected partition both include quantizing by a respective quantization parameter, and wherein the quantization parameter of the recoding is lower than the quantization parameter of the coding.

3. The video coding method of claim 1, wherein:
the segment corresponds to a sequence of video frames and
the partitions correspond to individual video frames.

4. The video coding method of claim 1, wherein:
the segment corresponds to an individual video frame, and
the partitions correspond to pixel blocks.

5. The video coding method of claim 1, wherein the base coding policy represents a default balance between data compression and recovered image quality and the second coding mode represents a coding policy that is an exception to the base coding policy.

6. The video coding method of claim 3, wherein, for at least one frame,
the base coding policy assigns the frame to be coded as an inter-coded frame, and
the second coding mode assigns the frame to be coded as an intra-coded frame.

7. The video coding method of claim 6, wherein the second coding mode assigns the frame to be coded as an IDR frame.

8. The video coding method of claim 3, wherein, for at least one pixel block,
the base coding policy assigns the pixel block to be coded as an inter-coded pixel block, and
the second coding mode assigns the pixel block to be coded as an intra-coded pixel block.

9. The video coding method of claim 3, wherein, for at least one pixel block,
the base coding policy assigns the pixel block to be coded as an inter-coded pixel block with one or more prediction references to a first set of one or more reference frames, and
the second coding mode assigns the pixel block to be coded as an inter-coded pixel block with one or more prediction references to a second set of one or more reference frames.

10. A video coding method, comprising:
for a segment of source video data, assigning respective coding modes for each of a plurality of partitions of the segment according to a coding policy,
coding each partition according to its assigned coding mode to generate first coded video data,
determining if the segment is homogenous, and
if the segment is homogenous:
selecting one or more partitions to be coded according to a second coding mode,
decoding the first coded video data of the selected partitions,
recoding the decoded video data of the selected partitions according to the second coding mode, and
generating a coded video output based on the recoded video data of the selected partitions and at least a portion of the first coded video data of the remaining partitions,
if the segment is not homogenous, generating a coded video output based on the first coded video data.

11. The video coding method of claim 10, wherein the coding and recoding of each selected partition both include quantizing by a respective quantization parameter, and wherein the quantization parameter of the recoding is lower than the quantization parameter of the coding.

12. A video coding method, comprising:
for a segment of source video data, assigning respective coding modes to each of a plurality of partitions of the segment according to a coding policy,
coding source video data of each partition according to its respective assigned coding mode to generate first coded video data,
determining whether a first coding mode of a first partition differs from coding modes assigned to neighboring partitions,
if the first coding mode of the first partition differs from coding modes assigned to neighboring partitions:
coding source video data of the first partition according to a second coding mode that corresponds to a coding mode of a neighboring partition to generate second coded data for the first partition,
decoding the second coded data of the first partition,
recoding the decoded data of the first partition according to the original coding mode of the first partition, and
generating a coded video output base on the recoded video data of the first partition and at least a portion of the first coded video data of the remaining partitions.

13. The video coding method of claim 12, wherein
the coding source video data of the first partition according to the first coding mode includes quantizing by a first quantization parameter, and
the coding source video data of the first partition according to the second coding mode includes quantizing by a second quantization parameter, lower than the first quantization parameter.

14. The video coding method of claim 12, wherein:
the segment corresponds to a sequence of video frames and
the partitions correspond to individual video frames.

15. The video coding method of claim 12, wherein:
the segment corresponds to an individual video frame, and
the partitions correspond to pixel blocks.

16. The video coding method of claim 15, wherein, for at least one frame,
the first coding mode causes the frame to be coded as an intra-coded frame, and
the second coding mode causes the frame to be coded as an inter-coded frame.

17. The video coding method of claim 16, wherein the first coding mode causes the frame to be coded as an IDR frame.

18. The video coding method of claim 15, wherein, for at least one pixel block,
the first coding mode causes the pixel block to be coded as an intra-coded pixel block, and
the second coding mode causes the pixel block to be coded as an inter-coded pixel block.

19. The video coding method of claim 15, wherein, for at least one pixel block,
the first coding mode causes the pixel block to be coded as an inter-coded pixel block with one or more prediction references to a first set of one or more reference frames, and
the second coding mode causes the pixel block to be coded as an inter-coded pixel block with one or more prediction references to a second set of one or more reference frames.

20. A video coding system, comprising:
a video coder having an input for source video data and an output for coded video data, the video coder selectively operating according to intra-coding and inter-coding modes,
a frame decoder to decode data of coded frames,
a controller to control coding of a segment of source video, the controller:
assigning a respective coding mode for each of a plurality of partitions of the segment according to a base coding policy,
causing the video coder to code each partition according to its assigned coding mode to generate first coded video data,
selecting one or more partitions to be coded according to respective second coding modes,
causing the video decoder to decode the first coded video data of the selected partitions,
causing the video coder to recode the decoded video of the selected partitions according to the respective second coding modes, and
a transmit buffer for storage of a coded video data signal that includes the recoded video data of the selected partitions and at least a portion of the first coded video data of the remaining partitions.

21. The video coding system of claim 20, wherein
the video coder comprises a quantization unit operating according to a quantization parameter, and
the quantization parameter applied by the video coder during the recode of the selected partitions is lower than the quantization parameter applied during the initial code of the selected partitions.

22. The video coding system of claim 20, wherein:
the segment corresponds to a sequence of video frames and
the partitions correspond to individual video frames.

23. The video coding system of claim 20, wherein:
the segment corresponds to an individual video frame, and
the partitions correspond to pixel blocks.

24. A video coding system, comprising:
a video coder having an input for source video data and an output for coded video data, the video coder selectively operating according to intra-coding and inter-coding modes,
a frame decoder to decode data of coded frames,
a controller to control coding of a segment of source video, the controller:
assigning a respective coding mode for each of a plurality of partitions of the segment a coding policy,
causing the video coder to code each partition according to its assigned coding mode to generate first coded video data,
determine whether a coding mode of a first partition differs from coding modes assigned to partitions neighboring the first partition,
if the original coding mode of the first partition differs from coding modes assigned to neighboring partitions:
causing the video coder to code source video data of the first partition according to a second coding mode that corresponds to a coding mode of a neighboring partition to generate second coded video data,
causing the video decoder to decode the second coded video data of the first partition,
causing the video coder to recode decoded data of the first partition according to the original coding mode of the first partition, and
a transmit buffer for storage of a coded video data signal based on the recoded video data of the first partition and at least a portion of first coded video data of other partitions.

25. The video coding system of claim 20, wherein
the video coder comprises a quantization unit operating according to a quantization parameter, and
the quantization parameter applied by the video coder during the recode of the first partition is lower than the quantization parameter applied during the original coding of the first partition.

26. The video coding system of claim 20, wherein:
the segment corresponds to a sequence of video frames and
the partitions correspond to individual video frames.

27. The video coding system of claim 20, wherein:
the segment corresponds to an individual video frame, and
the partitions correspond to pixel blocks.
